(19) United States
(12) Patent Application Publication
(10) Pub. No.: US 2002/0178342 A1
(43) Pub. Date: Nov. 28, 2002

(54) Information processing system

(76) Inventor: Tadashi Noguchi, Tokyo (JP)

Correspondence Address: Finnegan, Henderson, Farabow, Garrett & Dunner, L.L.P., 1300 I Street, N.W., Washington, DC, 20005-3315, US

(21) Appl. No.: 10/040,369

(22) Filed: Jan. 9, 2002

(30) Foreign Application Priority Data
Jan. 10, 2001 (JP) 2001-003094

(51) Int. Cl. G06F 15/00

(52) U.S. Cl. 712/1

(57) ABSTRACT

An information processing system and method are provided which can designate or change a location, to which data should be transferred or stored, easily and flexibly without placing any burden of programming on a user when the data extracted from a database is transferred to spreadsheet application software or the like. The information processing system comprises: search information storage module for storing search information for searching a database in association with identification information; identification information extracting module for scanning first data to be used by application software and extracting the identification information; search information extracting module for referring to the search information storage module and extracting the search information corresponding to the extracted identification information; data extracting module for selecting and searching the database on the basis of the extracted search information, thereby extracting and storing second data; and data inserting module for inserting the stored second data into the location from which the identification information of the first data has been extracted.

### FIELD OF THE INVENTION

The present invention relates to an information processing technique for transferring data, which is extracted from a database, to an application program. More particularly, this invention relates to a data transfer technique which enables the application program to designate a location to which data should be transferred.

### DESCRIPTION OF THE RELATED ART

Application software (hereinafter referred to as “AP”) exists, which includes a spreadsheet function that can control data in table form and perform arithmetic or other operations among various data stored in each element (cell) of a table.

Among such spreadsheet AP, there is spreadsheet AP that has a data transfer function of referring to an external database to extract certain data and of storing the extracted data in a data structure in table form used by the spreadsheet AP. Such data transfer function is executed in the two steps of setting a query (or selecting a query which is already set) and of executing the query. In some cases, the spreadsheet AP is structured in such a manner that the data transfer function enables the selection of a query which is set in an external database.

The format of a general query is shown below. The query is composed by including a data item to be extracted, the name of a database to be referred to, a data extracting condition or the like.

| | |
|---|---|
| Select: | data item to be extracted |
| From: | name of database to be referred to |
| Where: | data extracting condition |

### SUMMARY OF THE INVENTION

Conventional spreadsheet AP has a data transfer function of storing data extracted from an external database in a data structure in table form without any changes being made. However, the spreadsheet AP does not support any function of designating cell locations for storing data separately and making a table by laying out the extracted data arbitrarily.

Accordingly, when a user wants to designate the cell locations for storing data separately and make a table by laying out the extracted data arbitrarily, the user has to create a program by himself which realizes such function, using a programming language such as VB (Visual Basic) or the like, and this work imposes a heavy burden on the user.

Such problem is also caused when AP, other than spreadsheet AP, for example, browser AP, is used to interpret and display document data described in html (Hyper Text Markup Language) or the like. In other words, when a user wants to insert numerical data or text data extracted from an external database into document data described in html or the like, the user himself has to make a CGI (Common Gateway Interface) program having such function.

As for the spreadsheet AP, such a structure is proposed which reduces a user's burden by causing data transfer AP to intervene between the spreadsheet AP and the database and by giving the data transfer AP the function of designating the cell locations for storing data.

However, such data transfer AP is structured in such a manner that information for designating the cell locations to which data should be transferred is controlled inside the data transfer AP. Accordingly, in order to change a table layout, it is necessary to change the cell location designating information in the data transfer AP. In other words, in order to change the table layout, it is necessary to conduct the operation of changing data both on the spreadsheet AP and the data transfer AP, thereby causing the problem of requiring very complicated work for a user.

Accordingly, it is an object of the present invention to provide information processing technique which makes it possible to easily and flexibly designate and change a location to which data should be transferred (or a location for storing data) without placing any burden of programming on a user when transferring data which is extracted from a database to the spreadsheet AP or the like.

In order to achieve the above object, the information processing technique of the present invention includes; module (or step) of scanning first data to be used by application software and extracting information for searching a database; module (or step) of extracting second data from the database on the basis of the above extracted information; and module (or step) of inserting the second data into the location from which the above information of the first data has been extracted.

### BRIEF DESCRIPTION OF THE DRAWINGS

FIG. 1 is a block diagram illustrative of the structure of an information processing system, which is a first embodiment of the present invention.

FIG. 2 is an explanatory drawing illustrative of the structure of a schema (data structure in schema information storage module).

FIG. 3 shows an example of screen information output to a user.

FIG. 4 is a flow chart showing the flow of transfer process.

### DESCRIPTION OF THE PREFERRED EMBODIMENTS

(First Embodiment)

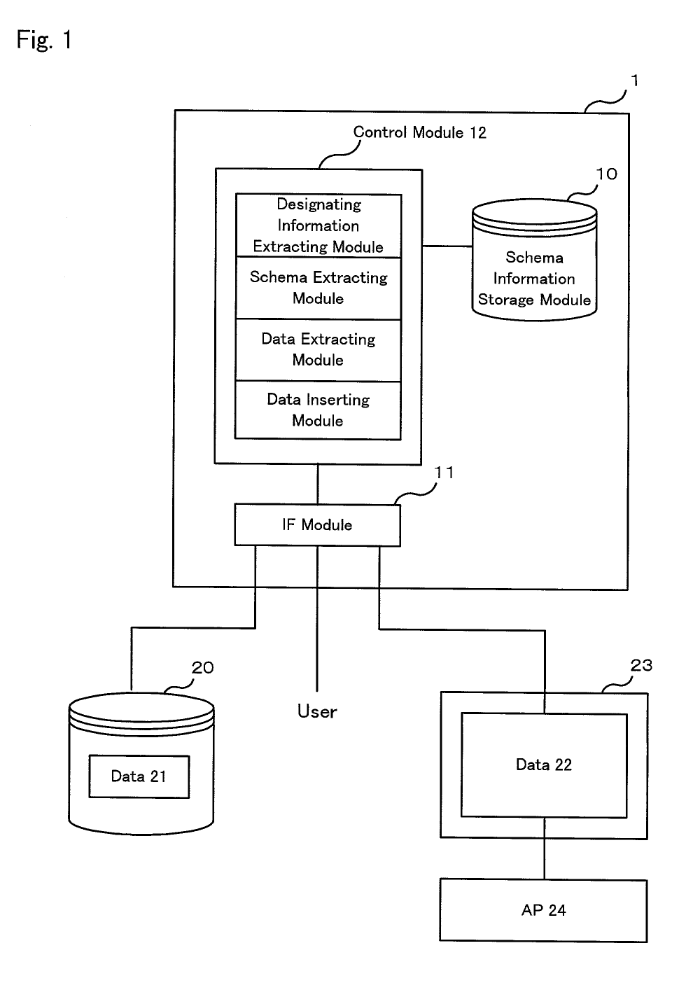

An embodiment of the present invention is hereinafter described with reference to the attached drawings. FIG. 1 is a block diagram illustrative of the structure of information processing system, which is a first embodiment of the present invention.

As shown in FIG. 1, an information processing system 1 of this invention includes schema information storage module 10, IF (interface) module 11, and control module 12. Moreover, the information processing system 1 is structured in such a manner that it is possible to access through the IF module 11 to an external database 20 and a storage module 23 which stores data 22, and it is also possible to receive input from a user and to output various kinds of information to the user.

The information processing system according to the present invention is adequate as long as it includes each of the above module, and either a dedicated system or general-purpose information processing device may be physically acceptable. For example, with the information processing device having a general structure, which includes a processing device, input module, storage module, and output module, it is possible to realize the information processing system of the present invention by activating software which defines each process of the information processing method of the present invention.

(Description of Object Data)

First, an explanation is hereinafter given about object data to be processed by the information processing system 1 or the like.

The external database 20 is structured using a general database technique, and contains data 21 which is to be transferred by the information processing system 1. As the data 21, various forms are possible, such as numerical data, text data, image data, and sound data.

The data 22 is the data to be used by AP 24. When the AP 24 is spreadsheet AP, the data 22 is tabular data. When the AP 24 is browser AP, the data 22 is document data such as html.

In the data 22, designating information is inserted beforehand by a user in accordance with specified rules, at a location into which the data 21 should be inserted.

The designating information is the information depending on its location to designate a location to which the data 21 should be transferred, and to designate conditions for extracting the data 21. The designating information can include schema identification information and information for searching a database (search key value(s)). The schema identification information is the information for specifying a schema to be stored in the schema information storage module 10 which will be described later, and the search key value is the information which is used as the extracting conditions at the time of the search of the external database 20. There may be more than one search key value. In that case, a database is searched according to the number of the contained search key values.

As for rules for locations, using the mark X which indicates the location of the designating information, a rule that “when the designating information is to be located in the data 22, the predetermined mark X (for example, ‘!!,’ or ‘&&’) should always be placed at the beginning and the end of the designating information” is applicable. In this case, different marks may be placed at the beginning and at the end.

Moreover, for example, when the data 22 is tabular data and if the location to which the data 21 should be transferred is designated by a cell unit, it is possible to apply a rule that “when the designating information is to be located in a cell of the data 22, the predetermined mark X should always be placed of the beginning of the cell.”

Furthermore, the above rules are examples, and any other rules may be applied as long as it is possible to scan the data 22 and extract the designating information.

(Description of Components)

Next, each component of the present information processing system 1 will be described.

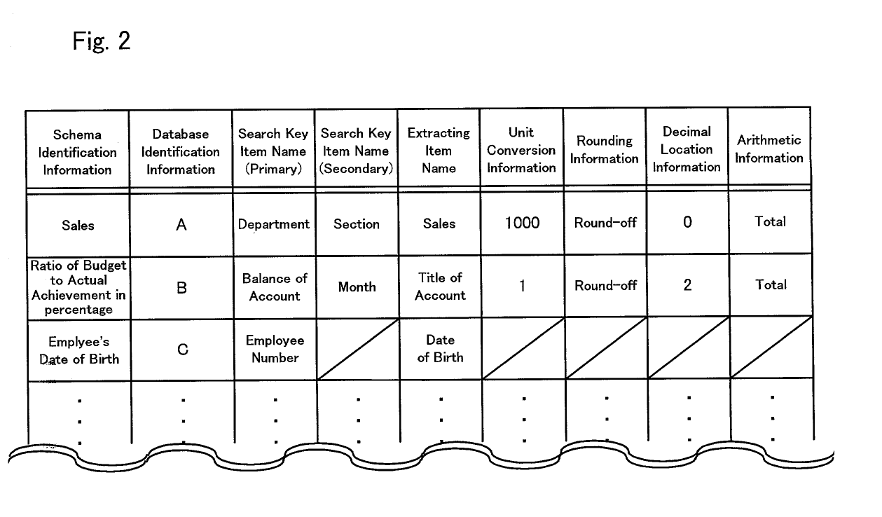

The schema information storage module 10 stores information for searching a database in association with the schema identification information and such information for searching a database includes database identification information, search key item names, and extracting item names. Such information for searching a database is called a schema (or reference definition). FIG. 2 shows an example of the structure of the schema.

When registering the schema, a user registers the schema identification information as information of a combination of numerals, letters, marks or the like. At this time, it is desirable to set the information to expressly specify the characteristics of the data 21 which is to be transferred. Moreover, the information processing system 1 may be programmed to automatically prepare and allot the schema identification information.

The database identification information is the information for specifying the database which stores and controls the data 21 which is to be transferred. For example, the name of the database may be used as the database identification information. Moreover, the database identification information may also include information specifying tables, queries or the like, which are included in the database.

The search key item name is the information for designating an item which becomes a search key. when a database is searched, a general method is to extract, as a search result, a record in which the item designated as the search key takes a desirable value. According to the first embodiment, an item to become the search key is designated by using the search key item name.

A plurality of search key items may be designated. In this case, the search key items are connected to each other by the logic operator “and” or “or.” The system has a structure, in which the schema includes information as to whether “and” or “or” is used for the connections. In the example shown in FIG. 2, the schema is structured in such a manner that two search keys (First and Second) can be designated.

The extracting item name is the information to designate an item concerning which data to be transferred, that is, the data 21, is stored within a database.

The schema may be structured to further include information to designate the execution of the specified conversion of numerical data as follows.

Unit Conversion Information

When the data 21 is numerical and is to be inserted in a transfer location by converting its unit, unit conversion information is used to designate the conversion. For example, if the numerical data 21 is in a “yen” unit and a user wants to insert it in the transfer location in a “ten thousand yen” unit, by designating 10,000 as the unit conversion information, unit conversion process (the process to divide the extracted numerical data by 10000) is performed with regard to the numerical data 21 at the time of the data transfer, and the converted numeral is then inserted into the transfer location. Moreover, the numeral “1” (no conversion) may be set as the default.

Round Information

When the data 21 is numerical and the numeral is to be rounded and inserted into the transfer location, rounding information is used to designate the way of rounding out the numeral. The rounding information includes information on how to round out the numeral, such as rounding off, rounding down, or rounding up, and digit information for rounding process. Moreover, the default setting may be made to round off the least significant digit.

Decimal Place Information

When the data 21 is a numeral having decimal places, decimal place information is used to designate what decimal place number should be effective for insertion into the transfer location. For example, if the numerical data 21 is 1.303 and second decimal places are designated as the decimal place information, the numeral 1.30 should be inserted into the transfer location. Moreover, the default rule may be set to insert the numerical data without changing decimal places (no designation).

Arithmetic Information

When a plurality of numerical data are extracted as the data 21, and if an arithmetic operation (including selection) is performed with regard to the plurality of data and the arithmetic operation result is then inserted into the transfer location, arithmetic information is used to designate the details of the arithmetic operation. Examples of the arithmetic operation include summation, averaging, selection of a minimum value, the selection of a maximum value, or selection of the first or the last extracted numerical data.

Moreover, other than those described above, the schema may include information of the name of a user who created or registered the schema, the date of creation or update, comments or the like.

The schema information storage module 10 may be structured in such a manner that it classifies and stores the schema in groups set in accordance with purposes or the like. For example, by classifying the schema into such schema groups as “a group for business purposes,” and “a group for private purposes” and by making it possible for a user to designate the schema group to be used at the time of the data transfer, the same schema identification information can be used selectively for different situations.

A conventional database technique such as a relational database can be used for controlling or searching for data in the schema information storage module 10.

The IF module 11 is structured to be accessible to the external database 20 and the storage module 23.

When the external database 20 and the storage module 23 are controlled by the control module 12, the IF module 11 functions by using OS installed in the information processing system 1. On the other hand, when the external database 20 and the storage module 23 exist within another independent computer system, the IF module 11 includes a communication module (for example, a PPP driver or TCP/IP driver when the IF module 11 is connected through the Internet) to connect or communicate with another computer system.

Moreover, the IF module 11 is structured to be capable of receiving input from a user through a keyboard or the like, and of outputting to the user various information by means of a display or the like. In addition, it may be structured to be capable of performing input and output to a user through the communication network. In this case, the IF module 11 includes a communication module to connect or communicate with an information processing terminal (such as a personal computer or a PDA (personal digital assistance) which each user generally has) used by a user. Moreover, in order to connect or communicate with a PDA such as a cellular phone, the connection is made through a specified external gateway (for example, the i-mode center of NTT DoCoMo).

The control module 12 controls the actions of the entire information processing system 1 and executes the data transfer process. The data transfer process will be described in detail in the following description of actions.

(Description of Actions)

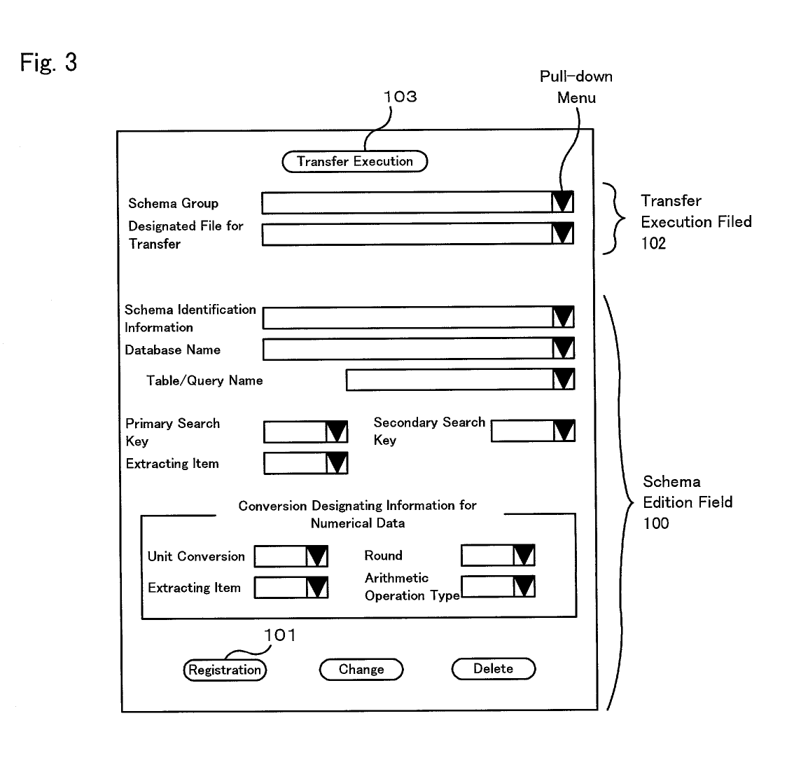

When the data transfer is conducted by using the information processing system1, the control module 12 first outputs to a user such screen information as shown in FIG. 3.

In order to perform schema editing (registration, alteration, or deletion), the user inputs each kind of information comprising the schema into the information processing system 1 on a schema editing field 100 of the screen information. Then, the user selects a registration button 101 or the like and then requests the information processing system 1 to execute the required process.

The control module 12 updates the contents stored in the schema information storage module 10 on the basis of the information received from a user.

At this time, the control module 12 performs: the process to check whether the schema identification information inputted by a user has been registered or used; the process to refer to the external database 20 corresponding to the database identification information inputted by the user, to read out tables, queries, and other data which are held by the database 20 and which can be selected, and to present the read out data to the user; and when a user wants to alter or delete a schema, the process to check whether the user himself created the schema to be altered or deleted.

Further, when transferring data, a user inputs, in a transfer execution field 102 of the screen information, for example, information for designating a schema group and information (such as a file name) for designating the data 22 to which the data transfer should be made, into the information processing system 1. Then, the user selects a transfer execution button 103 and requests the information processing system 1 to execute the transfer process. As for the schema group, the screen information may be designed to enable the input of a plurality of schema groups by assigning priorities to them.

(Transfer Process)

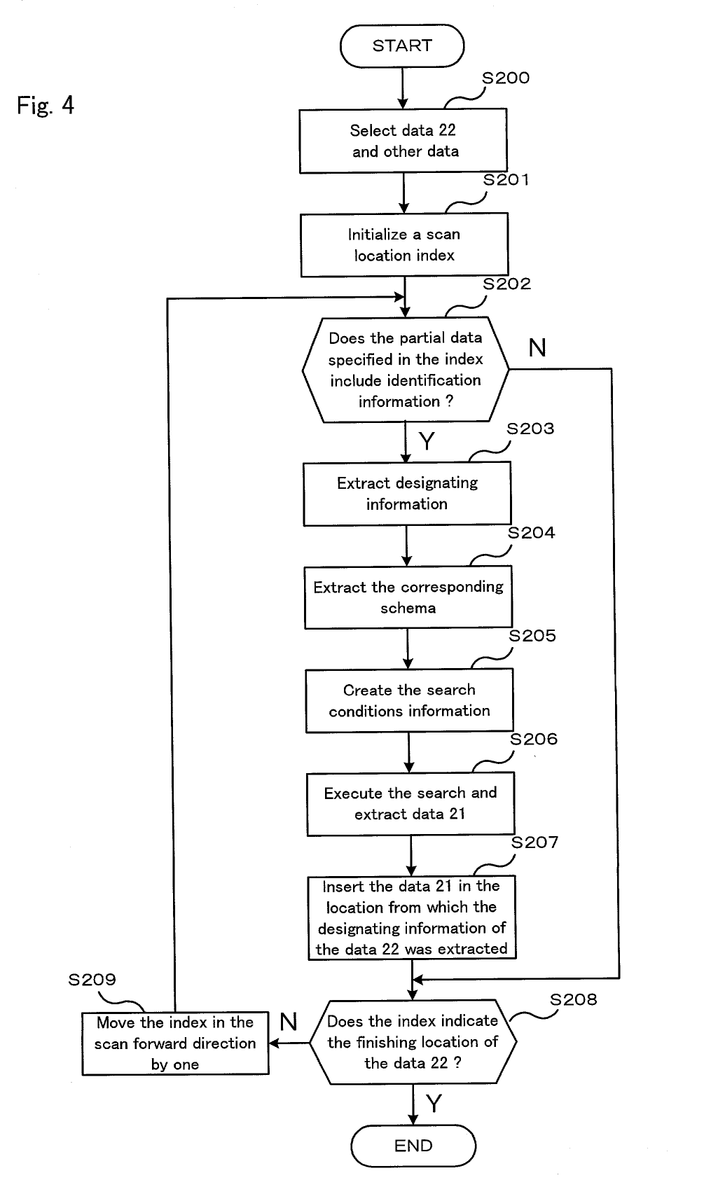

The transfer process includes: process to extract the designating information by scanning the data 22 (designating information extraction process); process to extract a schema corresponding to the extracted designating information by referring to the schema information storage module 10 (schema extracting process); process to extract the data 21 on the basis of the extracted schema by referring to the external database 20 (data extracting process); and process to insert the data 21 into the location in which the designating information of the data 22 was located (data inserting process). FIG. 1 shows each process as a functional module. The transfer process is described in detail below along with the flowchart shown in FIG. 4. The respective steps can be executed by changing the sequence thereof arbitrarily to the extent that no contradiction would occur in the processing contents.

First, the control module 12 selects a schema group or the data 22 on the basis of inputs by a user (Step S200). The system of this invention may be structured in such a manner that if the AP 24 is then executed by the control module 12, the data to be processed by the AP 24 is selected as the data 22 as the default.

Next, the control module 12 initializes a scan location index (Step S201). The scan location index is a variable for specifying a scan location in the data 22, and its initial value indicates an initial location (for example, a beginning location) in the data 22. If the data 22 is tabular data, the scan location index specifies a cell. If the data 22 is html document data, the scan location index specifies words or a phrase, or the like in the document.

Next, the control module 12 refers to the data 22 through the IF module 11, and reads out partial data (partial data of the data 22) which is specified by the scan location index. Then, the control module 12 determines whether the partial data includes the designating information (Step S202).

As a determining method, if such rule is adopted that “when the designating information is to be placed in the data 22, the predetermined mark X should always be placed at the beginning and the end of the designating information,” the determination is made based on whether or not there is any information between the marks X within the partial data.

If such rule is adopted that “when the designating information is to be placed in a cell of the data 22, the predetermined mark X should always be placed at the beginning of the cell,” the determination is made based on whether the partial data to be stored in the cell begins with the mark X or not.

If it is determined that the designating information is not included, it is then determined whether the scan location index indicates the finishing location (for example, the end location) of the data 22 (Step S208). If it indicates the finishing location, the transfer process is terminated. On the other hand, if it does not, the scan location index is then moved in the scan forward direction by one (Step S209), and the process returns to Step S202.

If it is determined that the designating information is included, the designating information is then extracted (Step S203). Subsequently, the control module 12 refers to the schema information storage module 10, reads out the selected schema group, and extracts the schema corresponding to the schema identification information included in the extracted designating information (Step S204).

Moreover, if a plurality of schema groups are selected, the control module 12 tries to extract a schema from a schema group in descending order of priority until it can extract the schema corresponding to the schema identification information.

Subsequently, the control module 12 creates the search condition information based on the search key item values included in the extracted designating information, the database identification information, search key item names, and extracting item names which are included in the extracted schema (Step S205). The search condition information can be structured, for example, as a query as follows:

| | |
|---|---|
| Select: | extracting item name |
| From: | database identification information |
| | (database name) |
| Where: | search key item name(s) = search key item |
| | value(s) |

Next, the control module 12 refers to the database 20 corresponding to the database identification information through the IF module 11, executes the search based on the search condition information created above, and extracts the data 21 (Step S206).

The control module 12 then refers to the data 22 through the IF module 11 and inserts the extracted data 21 into the location specified by the scan location index (Step S207), and then proceeds to Step S208.

Moreover, when the schema includes the unit conversion information, the rounding information, the decimal place information, arithmetic information, or the like, the control module 12 processes (by means of conversion, arithmetic operations or the like) the extracted data 21 based on such included information, and then inserts the processed value.

According to the first embodiment, the designating information placed in the data 22 is extracted and the data 21 extracted from a database on the basis of the designating information is inserted into the location in the data 22, in which the designating information is placed. Accordingly, it is possible to transfer the data 21 by designating the insertion location in the data 22 without the necessity of separately creating a program or the like for designating the insertion location.

Moreover, by placing the designating information in the data 22, it is possible to designate the location for inserting the data 21 in the data 22. Therefore, even when the insertion location is to be changed (when the layout is to be changed), the change is made by changing the location of the designating information in the data 22 without changing the internal data of the information processing system 1. Accordingly, it is possible to change the layout easily and flexibly.

Furthermore, because the designating information can include the information, such as the search key item value(s), for searching a database, it is possible to designate in the data 22 not only the insertion location, but also the extracting condition of the data 21 to be inserted. Therefore, it is possible to designate the data to be transferred (or inserted) more flexibly.

(Second Embodiment)

Next, a second embodiment of the present invention will be explained. The second embodiment includes a recording medium with an information processing program recorded therein. As the recording medium, a CD-ROM, a magnetic disc, a semiconductor memory, and other kinds of recording media can be used.

The information processing program is read from the recording medium into a data processing device, and controls the action of the data processing device. As controlled by the information processing program, the data processing device performs the same process as that of the schema information storage module 10, the IF module 11, and the control module 12 according to the first embodiment of the present invention.

(Others)

The present invention can be applied in variations without limitation to the above embodiments. For example, the external database 20 and the storage module 23 may be part of the information processing system 1. In addition, the control module 12 may be structured to be capable of running the AP 24.

According to the above embodiments, among the information for searching a database, the search key item value is included in the designating information placed in the data 22, and the information for specifying a database, and the search key item name are included in the schema which is stored in the schema information storage module 10. However, it is possible to decide, depending on a design, what information should be included in either the designating information or the schema. All the information needed for the search of a database may be compiled and included in either the designating information or the schema. If the information is compiled in the designating information, a structure is employed such that the schema is placed directly in the data 22 and, therefore, the schema information storage module 10 can be omitted.

Furthermore, explanations have been given about the structure of the above embodiments in which when a plurality of data are extracted from a database, the arithmetic operation is conducted with regard to the plural data and the result of the arithmetic operation is inserted into the data 22. In such case, it is also possible to insert each of the plural data into the data 22. In this case, when the data 22 is tabular data, the plural data are inserted into plural cells among which the cell with the designating information placed therein is located at the top. Moreover, by setting plural kinds of marks showing the location of the designating information and by extracting the designating information selectively based on the marks, a user can designate whether the arithmetic operation result of the plural data should be inserted or whether the plural data should be inserted separately in a certain order.

Moreover, such a structure may be employed that when the transfer process is repeatedly performed with regard to the same data 22, a user can designate at which time in the transfer process the data transfer should be executed, according to the kind of the mark which indicates the location of the designating information or according to the information which is included in the designating information or the schema. With such structure, the information for searching the database to be used in the next transfer process can be made to depend on the data 21 which has been inserted through the preceding transfer process.

Furthermore, when the AP 24, like a general spreadsheet AP, has the function to enable the setting of comment data (comment sentence(s) displayed when a certain cell is designated) according to a cell, the comment data corresponding to the designated cell as the transfer location can be registered as a part of the schema. In this case, such a structure may be employed that in addition to the step of inserting the data 21 into a cell, the transfer process comprises the step of setting the comment data included in the schema as the comment data of the cell into which the data 21 should be inserted. Moreover, a part of the data 21 may be used as the comment data.

In this specification, the term “module” does not only indicate a physical module, but it also includes the case in which any function of the module is actualized by software. Moreover, the function of one module may be actualized by two or more physical module, while the functions of two or more module may be actualized by one physical module as well.

The entire disclosure of Japanese Patent Application No. 2001-3094 filed on Jan. 10^{th}, 2001 including specification, claims, drawings and summary are incorporated herein by reference in its entirety.

What is claimed is:

1. An information processing system comprising:
module for scanning first data to be used by application software and extracting information for searching a database;
module for extracting second data from a database on the basis of the extracted information; and
module for inserting the second information into the location from which the information of the first data has been extracted.

2. An information processing system comprising:
search information storage module for storing first information (hereinafter referred to as the “first search information”) for searching a database in association with identification information;
identification information extracting module for extracting the identification information by scanning the first data to be used by application software;
search information extracting module for extracting the first search information corresponding to the extracted identification information by referring to the search information storage module;
data extracting module for extracting second data by searching a database on the basis of the extracted first search information; and
data inserting module for inserting the extracted second data into the location from which the identification information of the first data has been extracted.

3. The information processing system according to claim 2, wherein the first search information at least includes information for specifying a database and information for specifying a part or all of the search conditions.

4. The information processing system according to claim 2, wherein the identification information extracting module extracts, in addition to the identification information, second information (hereinafter referred to as the “second search information”) for searching a database, the second search information being located in association with the identification information, and the data extracting module searches a database on the basis of the first search information and the second search information.

5. The information processing system according to claim 4, wherein the second search information at least includes information for specifying a part or all of the search conditions.

6. The information processing system according to claim 2, wherein the system can register or update the first search information with the search information storage module on the basis of user input.

7. The information processing system according to claim 2, wherein the search information storage module stores a plurality of the first search information by classifying it into a plurality of groups.

8. The information processing system according to claim 1, wherein the application software is spreadsheet software and the first data is tabular data.

9. The information processing system according to claim 2, wherein the application software is spreadsheet software and the first data is tabular data.

10. The information processing system according to claim 1, wherein the application software is browser software and the first data is document data described in a structured tag language such as html.

11. The information processing system according to claim 2, wherein the application software is browser software and the first data is document data described in a structured tag language such as html.

12. The information processing system according to claim 1, wherein at least any one of the inputs or outputs to the application software, database, or the user, is performed through a communication network.

13. The information processing system according to claim 2, wherein at least any one of inputs or outputs to the application software, database, or the user, is performed through a communication network.

14. An information processing method comprising the steps of:
scanning first data to be used by application software and extracting information for searching a database;
extracting second data from a database on the basis of the extracted information; and
inserting the second data into the location from which the information of the first data has been extracted.

15. An information processing method comprising:
an identification information extracting step of scanning first data to be used by application software, thereby extracting identification information;
a search information extracting step of referring to search information storage module for storing first information (hereinafter referred to as the “first search information”) for searching a database in association with identification information, thereby extracting the first search information corresponding to the extracted identification information;
a data extracting step of searching a database on the basis of the extracted first search information, thereby extracting second data; and
a data insertion step of inserting the extracted second data into the location from which the identification information of the first data has been extracted.

16. The information processing method according to claim 15, wherein the first search information includes at least information for specifying a database and information for specifying a part or all of the search conditions.

17. The information processing method according to claim 15, wherein in the identification information extracting step, in addition to the identification information, second information is extracted (hereinafter referred to as the “second search information”) for searching a database, the second search information being located in association with the identification information, and
in the data extracting step, a database is searched on the basis of the first search information and the second search information.

18. The information processing method according to claim 17, wherein the second search information includes at least information for specifying a part or all of the search conditions.

19. The information processing method according to claim 15, further comprising the step of registering and updating the first search information with the search information storage module on the basis of user input.

20. The information processing method according to claim 15, wherein in the search information extracting step, at the time of reference to the search information storage module, a group in which the first search information is classified is designated and the first search information corresponding to the extracted identification information is extracted.

21. The information processing method according to the claim 14, wherein the application software is spreadsheet software and the first data is tabular data.

22. The information processing method according to claim 15, wherein the application software is spreadsheet software and the first data is tabular data.

23. The information processing method according to claim 14, wherein the application software is browser software and the first data is document data described in a structured tag language such as html.

24. The information processing method according to claim 15, wherein the application software is browser software and the first data is document data described in a structured tag language such as html.

25. The information processing method according to claim 14, wherein at least any one of inputs or outputs to the application software, a database, or the user is performed through a communication network.

26. The information processing method according to claim 15, wherein at least any one of inputs or outputs to the application software, a database, or the user is performed through a communication network.

27. A computer readable recording medium with a program stored therein for performing on a computer the information processing method according to claim 14.

28. A computer readable recording medium with a program stored therein for performing on a computerthe information processing method according to claim 15.
